(19) United States
(12) Patent Application Publication
(10) Pub. No.: US 2014/0322687 A1
(43) Pub. Date: Oct. 30, 2014

(54) COMPUTER SYSTEM FOR PROVIDING PHYSICAL THERAPY METHODS

(71) Applicant: CLINICAL PATTERN RECOGNITION LLC, Upland, CA (US)

(72) Inventors: Michael WONG, Upland, CA (US); Marshall Royce LEMOINE, Marina Del Rey, CA (US); Anne Meredith Fish LEMOINE, Marina Del Rey, CA (US); Emmanuel Yang YUNG, San Marino, CA (US)

(73) Assignee: CLINICAL PATTERN RECOGNITION LLC, Upland, CA (US)

(21) Appl. No.: 14/265,017

(22) Filed: Apr. 29, 2014

Related U.S. Application Data
(60) Provisional application No. 61/817,208, filed on Apr. 29, 2013.

(51) Int. Cl. G09B 23/28

(52) U.S. Cl. CPC G09B 23/28
USPC 434/262

(57) ABSTRACT

A computer system providing information relating to the delivery of physical therapy services to a patient suffering from a musculoskeletal impairment or a neuro-musculoskeletal impairment is provided. The computer system comprises at least one data store comprising a plurality of stored pain patterns; a plurality of physical examination therapy examination methods; and a plurality of physical therapy intervention methods. The computer system further comprises a data processing element, configured to select a stored pain pattern based on an input pain pattern and determine at least one physical therapy examination method and at least one physical therapy intervention method based on the selected stored pain pattern.

### CROSS-REFERENCE TO RELATED APPLICATIONS

This application claims priority to U.S. Provisional Patent Application No. 61/817,208, filed Apr. 29, 2013. The entire contents of U.S. Provisional Patent Application No. 61/817,208 is incorporated herein by reference.

### FIELD OF THE DISCLOSURE

The disclosure described herein relates to methods for providing physical therapy, and more particularly to a computer system that provides information relating to the delivery of physical therapy services.

### BACKGROUND OF THE DISCLOSURE

There exists a strong demand for physical therapy services, with physical therapists in the United States and elsewhere annually diagnosing and treating a substantial number of patients experiencing impaired mobility. The causes of impaired mobility in these patients range considerably and include injuries, such as back and neck injuries, strains, sprains and fractures and injuries related to work and sports, as well as a wide range of medical conditions including arthritis, amputations, stroke, birth conditions, e.g. cerebral palsy, and other conditions. A typical physical therapy session consists of a therapist assessing the functional constraints of a patient by direct observation, physical examination and review of available medical records. Upon formulating a diagnosis, remedial techniques prescribed by physical therapists may include postural, activity and movement corrections, massage, joint manipulation and other hands-on therapeutic treatments, patient education and instruction on lifestyle modification, therapeutic exercises, as well as other therapeutic modalities including heat and cold treatment, radiant energy, and using assistive or adaptive devices. Upon initiating rehabilitative intervention, the patient then typically provides feedback to the therapist relating to movements and postures, thereby allowing the therapist to further diagnose the patient and revise and/or refine the prescribed treatment, and ameliorating the impaired muscular mobility.

### SUMMARY OF THE DISCLOSURE

The present disclosure relates to several embodiments of computer systems that provide physical therapy services, and information relating to physical therapy services. Accordingly, the present disclosure provides at least one example implementation of a computer system for providing information relating to the delivery of physical therapy services the computer system comprising:
(a) at least one data store assembled in electronic readable format comprising:
   a plurality of stored pain patterns relating to a musculoskeletal or neuro-musculoskeletal impairment of a patient; a plurality of physical therapy examination methods to examine the musculoskeletal or neuro-musculoskeletal impairment; and
   a plurality of physical therapy intervention methods to treat the musculoskeletal or neuro-musculoskeletal impairment;
(b) a data processing element, operably coupled to the at least one data store, and configured to select a stored pain pattern based on an input pain pattern and then select at least one of at least one physical therapy examination method and at least one physical therapy intervention method based on the selected stored pain pattern;
(c) a user input module, operably coupled to the data processing element, operable to receive user input data comprising the input pain pattern; and
(d) a user output module, operably coupled to the data processing element, operable to provide output data to an output device comprising the selected physical therapy examination method and the selected physical therapy intervention method.

Other features and advantages of the present disclosure will become apparent from the following detailed description. It should be understood, however, that the detailed description, while indicating preferred implementations of the disclosure, are given by way of illustration only, since various changes and modifications within the spirit and scope of the disclosure will become apparent to those of skill in the art from the detailed description.

### BRIEF DESCRIPTION OF THE DRAWINGS

For a better understanding of the various example embodiments described herein, and to show more clearly how these various embodiments may be carried into effect, reference will be made, by way of example, to the accompanying drawings which show at least one example embodiment and the drawings will now be briefly described.

FIG. 1 shows a high level schematic block diagram illustrating an example implementation of a computer system according to an implementation of the disclosure.

FIG. 2 shows a high level schematic block diagram illustrating another example implementation of a computer system according to an implementation of the disclosure wherein the memory element of the computer system comprises four data stores.

FIG. 3 shows a high level schematic block diagram illustrating another example implementation of a computer system according to an implementation of the disclosure wherein the memory element of the computer system comprises five data stores.

FIG. 4 shows a high level schematic block diagram illustrating another example implementation of a computer system according to an implementation of the disclosure wherein the central terminal of the computer system is networked to a plurality of user input modules and user output modules;

FIG. 5 shows a high level schematic block diagram illustrating another example implementation of a computer system according to an implementation of the disclosure wherein the central terminal of the computer system is networked to a plurality of user input modules and user output modules, and wherein the central terminal is configured to control access by the input devices;

FIG. 6 shows a high level schematic block diagram illustrating example implementation of a memory element of the computer system according to an implementation of the disclosure; and

FIG. 7 shows a flow chart illustrating an example implementation of a process conducted by the computer system according to an implementation of the disclosure.

The drawings together with the following detailed description make apparent to those skilled in the art how the disclosure may be implemented in practice.

### DETAILED DESCRIPTION OF THE DISCLOSURE

Various apparatuses or processes will be described below to provide an example of an embodiment of each claimed subject matter. No embodiment described below limits any claimed subject matter and any claimed subject matter may cover processes, apparatuses, devices or systems that differ from those described below. The claimed subject matter is not limited to apparatuses or processes having all of the features of any one apparatus, device, system or process described below or to features common to multiple or all of the apparatuses, devices, systems or processes described below. It is possible that an apparatus, device, system or process described below is not an embodiment of any claimed subject matter. Any subject matter disclosed in an apparatus, device, system or process described below that is not claimed in this document may be the subject matter of another protective instrument, for example, a continuing patent application, and the applicants, inventors or owners do not intend to abandon, disclaim or dedicate to the public any such subject matter by its disclosure in this document.

It should be noted that terms of degree such as “substantially”, “about” and “approximately” as used herein mean a reasonable amount of deviation of the modified term such that the end result is not significantly changed. These terms of degree should be construed as including a deviation of the modified term if this deviation would not negate the meaning of the term it modifies.

As used herein, the wording “and/or” is intended to represent an inclusive- or. That is, “X and/or Y” is intended to mean X or Y or both, for example. As a further example, “X, Y, and/or Z” is intended to mean X or Y or Z or any combination thereof.

One limitation in the currently used methodologies in physical therapy is that it is frequently challenging for a physical therapist to select an examination method from the myriad of possible examination methods based on the functional constraints observed in a patient. Errors in the examination method selected may result in a flawed diagnosis and inappropriate therapeutic intervention. Moreover, once the examination methodology is selected, it is frequently challenging for physical therapists to efficiently implement the selected examination methodology.

A further limitation in the currently used methodologies in physical therapy is that it is frequently challenging for a physical therapist to select a therapeutic intervention method from the myriad of possible intervention methods based on the mobility constraints and examination performed. Errors in the selection of the intervention method may lead to a sub-optimal rehabilitation of the patient. In addition it is frequently challenging for physical therapists to efficiently implement the intervention methods.

Yet a further limitation of the currently used methodologies in physical therapy is that the physical therapist and patient are generally located together. This restricts access to physical therapists for some patients, especially in remote and medically underserviced regions and limiting the options for outpatient treatment, providing an undue burden on such patients.

There is therefore a need in the art to improve physical therapy services, and the delivery thereof.

As hereinbefore mentioned, the present disclosure relates to a computer system for providing physical therapy services. Accordingly, the present disclosure provides a computer system generally comprising a data store linking a plurality of stored pain patterns relating to musculoskeletal or neuro-musculoskeletal impairment, to physical therapy examination methods for such impairments and the physical therapy intervention methods to treat such impairments. A user input module allows a user to provide input in the form of an input pain pattern and a user output module allows a user to receive output in the form of a physical therapy examination method and a physical therapy intervention method. In preferred implementations, the output may be provided in the form of a movie comprising a sequence of images displaying the positioning and orientation of a body part over time. The here provided disclosure provides at least one example implementation of a computer system that in a convenient manner allows for a rapid selection of an examination method from a multitude of possible examination methods, and, optionally, rapid review of how to implement such examination methods, based on a reported pain pattern. The computer system further allows for a rapid selection of a therapeutic intervention method from a multitude of therapeutic intervention methods, and optionally, a rapid review of how to implement such intervention method. The computer system limits the possibility of the selection of an inappropriate examination methodology or intervention methodology, and further allows for a convenient and rapid review of selected examination and intervention methodologies, thus increasing the possibility of successfully treating the musculoskeletal or neuro-musculoskeletal impairment as well as improving the rehabilitation of the patient.

Accordingly, in one aspect, the present disclosure provides a computer system for providing information relating to the delivery of physical therapy services the computer system comprising:
(a) at least one data store assembled in electronic readable format comprising:
   a plurality of stored pain patterns relating to a musculoskeletal or neuro-musculoskeletal impairment of a patient;
   a plurality of physical therapy examination methods to examine the musculoskeletal or neuro-musculoskeletal impairment; and
   a plurality of physical therapy intervention methods to treat the musculoskeletal or neuro-musculoskeletal impairment;
(b) a data processing element, operably coupled to the at least one data store, and configured to select a stored pain pattern based on an input pain pattern and then select at least one of at least one physical therapy examination method and at least one physical therapy intervention method based on the selected stored pain pattern;
(c) a user input module, operably coupled to the data processing element, operable to receive user input data comprising the input pain pattern; and
(d) a user output module, operably coupled to the data processing element, operable to provide output data to an output device comprising the selected physical therapy examination method and the selected physical therapy intervention method.

The term “computer system” as used herein refers to any device with an electronic processing element capable of executing instructions, including but not limited to, any personal computer, desktop computer, hand-held computer, lap-top computer, tablet computer, cell phone computer or smart phone computer or other suitable electronic device.

The term “coupled” as used herein can have several different meanings depending on the context in which the term is used. For example, the term coupling can have a mechanical or electrical connotation depending on the context in which it is used; i.e. whether describing a physical layout or transmission of data as the case may be. For example, depending on the context, the term coupling may indicate that two elements or devices can be directly physically or electrically connected to one another or connected to one another through one or more intermediate elements or devices via a physical or electrical element such as, but not limited to, a wire, a non-active circuit element (e.g. resistor) and the like, for example.

The term “data store” refers to any device or combination of devices capable of storing, accessing, and retrieving data, including, without limitation, any combination and number of data servers, databases, tables, files, lists, queues, directories, data storage devices, data storage media and the like.

The term “output device” as used herein refers to any device that is used to output information and includes, but is not limited to, one or more of a terminal, a desk top computer, a laptop, a tablet, a cellular phone, a smart phone, a printer (e.g. laser, inkjet, dot matrix), a plotter or other hard copy output device, speaker, headphones, electronic storage device, a radio or other communication device, that could communicate with another device, or any other computing unit. Output devices may comprise a two dimensional display, such as a TV or a liquid crystal display (LCD), a light-emitting diode (LED) backlit display, a mobile telephone display, a three dimensional display capable of providing output data in a user viewable format.

The term “input device” as used herein refers to any user operable device that is used to input information and includes but is not limited to, one or more of a terminal, a desk top computer, a laptop, a tablet, a cellular phone, a smart phone, a touch screen, a keyboard, a mouse, a mouse pad, a tracker ball, a joystick, a microphone, a voice recognition system, a light pen, a camera, a data entry device, such as a bar code reader or a magnetic ink character recognition device, sensor or any other computing unit capable of receiving input data. Input devices may comprise a two dimensional display, such as a TV or a liquid crystal display (LCD), a light-emitting diode (LED) backlit display, a mobile telephone display, a three dimensional display capable of receiving input from a user e.g. by touch screen. The user in accordance herewith may be any user including any patient, physical therapist, student, or physical therapy instructor.

The term “pain pattern” as used herein refers to a representation of a pain or a series of pains experienced by a patient with a musculoskeletal impairment or a neuro-musculoskeletal impairment. The representation may be a written text description of a pain and a specific portion of the body in which the pain is experienced, or a graphical representation of an area of pain localized in a specified portion of the body, for example in the form of a body chart or other graphical representation of a body, in which the area in which pain is experienced, such as, for example, an ankle, foot, knee, hip, pelvis, shoulder, elbow, wrist, hand, spine or a combination of any or all of the areas, or a portion thereof, e.g. a toe, a finger, or a specific joint, bone or muscular portion thereof, for example, is specifically indicated. Pain patterns further may include qualifying descriptions of one or more of the intensity (e.g. weak, intermediate, strong), duration, direction and type of pain e.g. chronic pain, sub-acute pain, acute pain, burning pain, radiating pain, sharp pain, dull pain, vague, stabbing, tingling etc. The pain pattern is embodied in a data file that may be a text file, an HTML file, an image, a movie, an audio file and the like.

As used herein the term “stored pain pattern” refers to a clinically recognized condition resulting from a musculoskeletal impairment or a neuro-musculoskeletal impairment that is stored in a data store, such as, for example “lumbar stiffness”, “lumbar instability”, “lumbar disc disorder. The stored pain pattern is a data file that is stored on at least one data store and may be a text file, an HTML file, an image, a movie, an audio file and the like.

As used herein the term “input pain pattern” refers to an anatomical component or area identifiable to the human body, e.g. the exterior thereof, actually or possibly experiencing pain as a result of musculoskeletal impairment or a neuro-musculoskeletal impairment, e.g. an elbow, a knee, a hip, a joint, or lower back area experiencing pain. An input pain pattern is provided as input data which may be in various formats. For example, an input pattern may be text, audio, an image, a video and the like.

The terms “physical therapy” and “physiotherapy”, which may be used interchangeably herein, refer to any form of remedial or rehabilitating therapy involving, but not limited to, one or more of identification, differentiation, examination, synthesis, prognosis, evaluation, diagnosis, instruction and intervention to ameliorate acute, subacute or chronic impaired mobility in a human patient. Physical therapeutic treatments may include one or more of exercises and physical activities, massage, mobilization, manipulation, functional and endurance training, patient education, movement and lifestyle modification. Physical therapeutic treatments may also possibly include the use of one or more of heat, cold, water, radiant energy, electricity and sound. Physical therapeutic treatments may also possibly include the use of one or more assistive or adaptive devices and equipment such as braces and splints. The term “physical therapy related information” refers to any and all information relating to physical therapy, including, without limitation, methods for conducting physical therapy, methods for examining or diagnosing impairments which may be ameliorated using physical therapy, and the like.

The term “musculoskeletal impairment” refers to dysfunction in the anatomical and physiological system of one or more muscles, tendons, ligaments, bones and joints and associated tissues that maintain the form of the body and movements of the body. The musculoskeletal impairment may result in one or more of impaired muscular strength, impaired mobility or impaired motor coordination, which in turn may be linked to functional limitations in a patient, and in participation restrictions and/or disability.

The term “neuro-musculoskeletal impairment” refers to a dysfunction in one or more of the nerves, muscles, tendons, ligaments, bones and joints and associated tissues that maintains the form of the body and movements of the body. The neuro-musculoskeletal impairment may result in one or more of impaired muscular strength, impaired mobility or impaired motor coordination, which in turn may be linked to functional limitations in a patient, and in participation restrictions and/or disability.

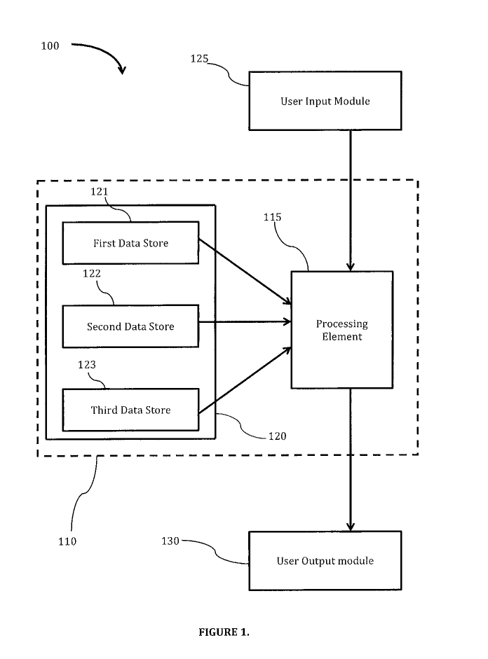

Referring to FIG. 1, the present disclosure provides an example implementation of a computer system 100 comprising a user output module 130, a processing device 115, a memory element 120, and a user input module 125.

The memory element 120 comprises a tangible storage medium operable to store computer readable data and instructions. In accordance herewith, the tangible storage medium may be any storage medium, such as, but not limited to, an electrical magnetic or optical storage medium, and the storage medium may be implemented using any suitable technique or methodology known to those skilled in the art, such as, but not limited to random access memory (RAM), disk storage, flash memory, solid state memory, CD-ROM, and so on.

The memory element 120 comprises a first, a second and a third data store 121, 122, and 123, respectively, with each data store comprising data assembled in electronic readable format. The term “assembled in electronic readable format” as used herein means any file, application, module or other data that is useable by the processing element 115. As used herein, an application or module includes code executable by the processing element 115 that may be run to carry out one or more functions associated with the user input module 125 and the methods to implement the methods of the disclosure. The term “code executable by the processing element” as used herein includes any computer-readable media or commands that may be interpreted by the processing element 115, such as HTML or XML files, C, C++, SQL or other suitable computer files, that are rendered into user-viewable applications by an application executed by the processing element, 115.

The first data store 121 comprises a plurality of stored pain patterns, assembled in a computer readable data format, relating to musculoskeletal or neuro-musculoskeletal impairment. The stored pain patterns may be stored in any kind of format, including, text files, HTML files, images, movies and the like. In preferred implementations stored pain patterns are assembled as a body chart comprising graphical representations of specific areas of the body in which pain is experienced, including graphical representations of one or more of a foot, ankle, knee, hip, pelvis, shoulder, elbow, wrist, hand, spine or a combination of any or all of the areas, or a portion of thereof, e.g. a toe, a finger, or a specific joint, bone or muscular portion thereof.

The second data store 122 comprises a plurality of physical therapy examination or testing methods, assembled in a computer readable data format, relating to musculoskeletal or neuro-musculoskeletal impairment. There may be for example 50, 100, 500 or 1000 or in some implementations even more examination methods. These physical therapy examination or testing methods are preferably represented as at least one visual image of a position or orientation of a part or all of the human body, preferably an exterior part of the human body. Thus for example an arm, a knee or a back of a human body may be shown together with instructions on how to perform examination. The physical therapy examination methods may be any examination methods to assess acute or chronic impaired mobility in a patient, including but not limited to any screening examinations, objective examinations, manual and/or movement examinations and special tests such as, including but not limiting to, depression tests, anxiety tests, kinesiophobia tests, and still further include catastrophizing screens, strength, range of motion and neurological exams. In preferred implementations hereof, the physical therapy examination or testing methods are represented as a movie comprising a sequences of visual images of positions or orientations of a part of the human body. Thus a movie showing for example arm movement, knee movement or back movement may be shown. In particularly preferred implementations, healthy and impaired or faulty representations are provided.

The third data store 123 comprises a plurality of physical therapy intervention methods, assembled in a computer readable data format, to treat at least one of musculoskeletal or neuro-musculoskeletal impairments. There may be, for example, 50, 100, 500 or 1000 or in some implementations even more intervention methods. These physical therapy intervention methods are preferably represented as at least one visual image of a portion of a position or orientation of a part of the human body, preferably an exterior part of the human body. Thus for example an arm, a knee or a back of a human body may be shown together with instructions on how to perform physical therapy. In preferred implementations hereof, the physical therapy intervention methods are represented as a movie comprising a sequence of images of positions or orientations of a part of the human body. The physical therapy intervention methods may be any remedial or rehabilitating therapy methods to ameliorate or correct acute or chronic impaired mobility in a human patient, including one or more exercises, physiotherapeutic exercises, exercise for patient and motor re-education and physical activities, exercises for motor coordination, massage, manual therapy, mobilization, manipulation, joint mobilization and joint manipulation, nerve mobilization, functional and endurance training, patient education, movement and lifestyle modification. Optionally, the physical intervention methods may use other modalities including one or more of the use of heat, cold, water, radiant energy, electricity and sound. Optionally, the physical therapy intervention methods may use one or more assistive or adaptive devices and equipment including braces and splints.

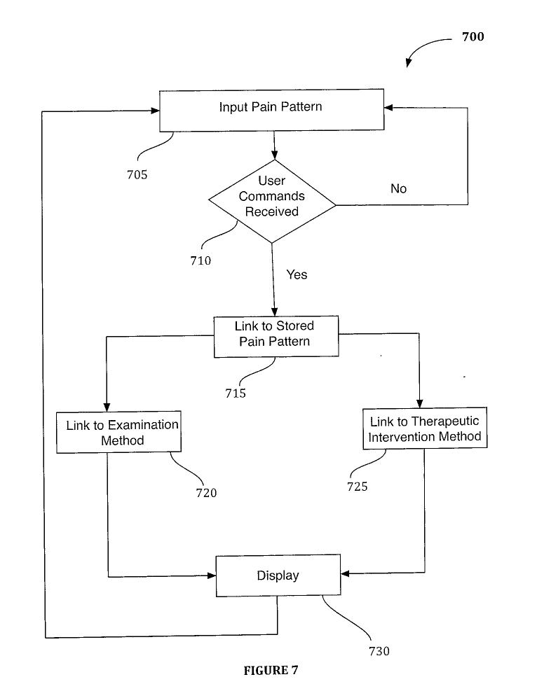

The methods of the computer system of the present disclosure are further illustrated in FIG. 7, which shows, as an example embodiment, a flowchart for the execution of a process 700 for providing information relating to the delivery of physical therapy services to a patient suffering from a musculoskeletal impairment or a neuro-musculoskeletal impairment in accordance with the present disclosure. The process 700 starts with the loading of an interface capable of receiving commands or information to provide one or more input pain patterns (step 705). After the process 700 is started, it waits for a user input command which may be in the form of a selection of one or more input pain patterns (step 710). The input pain pattern may, for example, comprise a text command to identify a pain characteristic (e.g. written: “knee pain”, “lower back pain”, “elbow pain”), an audio command (spoken: “knee pain”, “lower back pain”, “elbow pain”), or commands based on one or more graphical representations of pain characteristics. In the latter implementation, an input pain pattern may be provided to the system by the user by identifying and selecting a specific area experiencing pain within a graphic representation of the human body or a portion thereof. Thus using, for example, a mouse or computer touch screen, a user may select, within a graphical representation of a human body select, a particular area of body part such as, but not limited to, a knee, lower back and the like in order execute step 710. Once user input command is provided, the computer system links or matches the input pain pattern to one or more stored pain patterns (step 715).

Thus, by way of example only, an input pain pattern command provided by the characteristic “lower back pain” may be given by a user (e.g. as a text command, audio command or graphical command), and the lower back pain input pain pattern then is linked to, for example, stored pain patterns “lumbar stiffness”, “lumbar instability”, “lumbar disc disorder”, “lumbar spine fusion” etc. The matching may conveniently be achieved by assigning unique identifiers, e.g. unique numerical identifiers to input pain patterns and match these to identifiers of stored pain pattern. Thereafter the system links the identified stored pain pattern or patterns to a physical examination method (step 720) and a therapeutic intervention method (step 725). The physical examination method and the therapeutic intervention method may then be displayed on an output device (step 730).

The computer system 100 further comprises a data processing element 115 which is at least one processor or other suitable hardware that can execute and perform computer readable instructions, which may be accessed from a disc, a memory element, or other device capable of storing instructions thereon. These computer readable instructions cause the data processing element 115 upon user operation of the user input module 125 to acquire input data comprising an input pain pattern, select a stored pain pattern from the first data store 121, and then select at least one examination methodology from the second data store 122, and at least one an intervention methodology from the third data store 123 based on the selected stored pain pattern.

The specific links between an input pain pattern provided by the user's operation of the input device 125 and the stored pain patterns and the examination methodologies and intervention methodologies are generally established based on known physical therapy practice, including on clinical practice guidelines, pattern recognition, ICF-various-forms of medical classifications (including but not limited to the World Health Organization's international classification of functioning and disability (ICF), and the World Health Organization's international classification of diseases (ICD)), patterns of impaired or faulty movement, or clinical reasoning and other medical information, and translated into individual electronic readable instructions. The pain patterns are linked or matched to a list of possible hypotheses by the combined use of available research, clinical practice guidelines and clinical expertise.

For example, in accordance herewith, each stored pain pattern may be labeled with a unique identifier, e.g. a unique numerical identifier, and linked to or otherwise associated with one or more examination methodologies and one or more intervention methodologies, each of which may be labeled with a unique identifier, based on the medical knowledge of what examination and intervention method to use depending on the pain pattern. Thus, by way of example only, a stored pain pattern such as “lumbago with sciatia” may be linked with examination instructions for a specific manual evaluation of the lower back area and testing for pain radiating into the legs, and the intervention methodology may comprise one or more specific manual intervention or back stretching and strengthening exercises. In this case, the selected stored pain pattern, one or more examination methodologies and one or more intervention methodologies may be determined by matching their identifiers with the identifier of the input pain pattern.

In another implementation, the selected stored pain pattern may be determined based on the input pain pattern in different ways depending on the format used for the input pain pattern. For example, if the input pain pattern is in a text form, image form or movie form, then pattern matching techniques for text, images or movies, as the case may be, may be used to select a stored pain pattern that matches or correlates best with the input pain pattern.

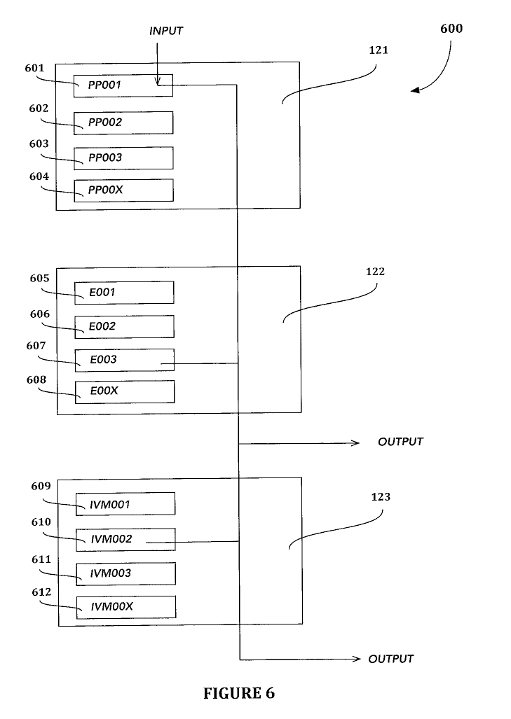

An example of the foregoing is further described in FIG. 6, showing a memory element 600, comprising a first, second and third data store, 121, 122 and 123, respectively. Data store 121 comprises stored pain patterns PP001 (601), PP002 (602), PP003 (603) and PP00X (604). Data store 122 comprises stored examination methodologies E001 (605), E002 (606), E003 (607) and E00X (608). Data store 123 comprises stored intervention methodologies IVM001 (609), IVM002 (610), IVM003 (611) and IVM00X (612). Stored Pain pattern PP001 (601), in the example embodiment, has been linked (using the above described methodologies) with an examination methodology E003 (607) and with an intervention methodology IVM002 (610). Thus, when an input command comprising an input pain pattern that is linked to stored pain pattern PP001 (601) is communicated to a processing element (not shown for ease of illustration), the processing element 115 will provide output in the form of E003 (607) and IVM002 (610). As hereinbefore mentioned, each data store may contain substantially more stored pain patterns, examination methodologies and intervention methodologies as are shown in FIG. 6. In addition the links may be more complex, for example a single stored pain pattern may be linked with 2 or more examination methodologies and/or 2 or more intervention methodologies.

In preferred implementations, the examination methodology may include a representation of one or more faulty or impaired muscular movement patterns. Thus, for example, the faulty movement pattern of excessive flexion of the spine, instead of bending at the knees and hips when picking an object up from the ground, may be an indication of disc herniation. The user will be comparing the faulty movement actually experienced or observed, with a representation of a faulty movement provided to the user via the user output module to be able to examine a condition. In further preferred implementations, stored pain patterns comprising different pain intensities, are taken into consideration in the correlation between the stored pain pattern, and the examination methodology and the intervention methodology. The links may be adjusted from time to time as new medical insights and understandings emerge.

In at least some implementations, a stored pain pattern is linked with one examination methodology and with one intervention methodology.

In other implementations a stored pain pattern is linked with a small number of examination methodologies, for example, 2, 3, 4 or 5 methodologies and/or with a small number of intervention methodologies, for example 2, 3, 4 or 5 methodologies, which conveniently may be presented to the user via output module 130, in order of priority, The order of priority may be included in the system based on the input pain pattern information provided and/or medical knowledge and guidelines regarding preference among specific examination or treatment options.

In preferred implementations, the memory element 120 and the processing element 115 are located together in the terminal 110. A user input module 125 is operable to receive input from a user in the form of an input pain pattern identified by the user. The user input module 125 is operably coupled to the processing element 115 and capable of conveying the input from the user to the processing element 115.

In order to operate the user input module 125 the user identifies an input pain pattern by selecting a user input pain pattern provided to the user via input module 125 by display of descriptions, images, graphics, live recorded video, audio or other representations of input pain patterns operably provided to the user input module 125 from the data store 121. The user may select such representation, through, for example, the use of a keypad, mouse or touch screen operation of the input module 125, thereby communicating the input pain pattern to the processing element. In some embodiments, at least two of these input mechanisms may be available to the user. In some embodiments, all three of these input mechanisms are available to the user. In some implementations, the input module 125 further may comprise a capability permitting the user to select whether he wishes to receive output from the second data store, 122 alone or the third data store 123 alone, or from both the second data store 122 and the third data store 123. In addition, in the event the user wishes to receive the output from both data stores 122 and 123, in some implementations, the output data may be provided simultaneously and in other implementations the output data may be provided sequentially. In the latter case in some embodiments, the user may be allowed to select the order in which the output data is received.

A user output module 130 is operable to provide user output conveying at least one of an examination methodology and a therapeutic intervention methodology. The user output module 130 is operably coupled to the processing element 115, which determines which examination and/or intervention methods are communicated to the output device. In particularly implementations, the user output module 130 comprises at least one two dimensional display such as, but not limited to a TV screen, a liquid crystal display (LCD), a light-emitting diode (LED) backlit screen, a mobile phone screen, a three dimensional display capable of providing output in a user viewable format, a printer, or an electronic storage device, and provides the examination methodology and/or the therapeutic intervention methodology as one or more of an application, image or graphics displaying the position or orientation of a portion or all of the human body.

In a further preferred implementation, the user output module 130 provides the examination and/or the intervention methodology in the form of a movie displaying a sequence of images of the position or orientation of a portion or all of the human body, which may include one or more healthy and impaired or faulty positions and orientations and/or muscular movements. The movie may be in graphics or animation format, or comprise live recorded video, and further may comprise stored information including for example recorded broadcasts, pay-per-view items and/or buffered portions of a live video broadcast. Preferable formats used to display an image in accordance herewith include, but are not limited to, Portable Network Graphics (PNG) or other appropriate user-viewable formats, such as, but not limited to, for example, Tagged Image File Format (TIFF), and Joint Photographic Experts Group (JPEG). Preferable formats used to display a video in accordance herewith include, but are not limited to, Motion Picture Experts Group (MPEG-2, MPEG-4), for example.

Video and animations may typically be very short or short in duration, e.g. less than 20 seconds, less than 30 seconds, less than 60 seconds or less than 5 minutes. As a result of commands or a setting from a user, videos or images may be stored locally in the user output module 130. The examination methodology may be provided to the user by the user output module 130 simultaneously with the intervention methodology or the examination methodology may be provided separately from the intervention methodology. The user input module 125 and/or the user output module 130 may be separated from the terminal 110 or the user input module 125, the user output module 130 and the terminal 110 may be constituted to be located all together in one physical device.

The user may be a patient of a physical therapist or any other user interested in using the computer system.

The various implementations of the computer system of the present disclosure allow a user to rapidly correlate a pain pattern with at least one of an examination methodology and an intervention methodology and to efficiently review an examination methodology and/or an intervention methodology prior to implementation.

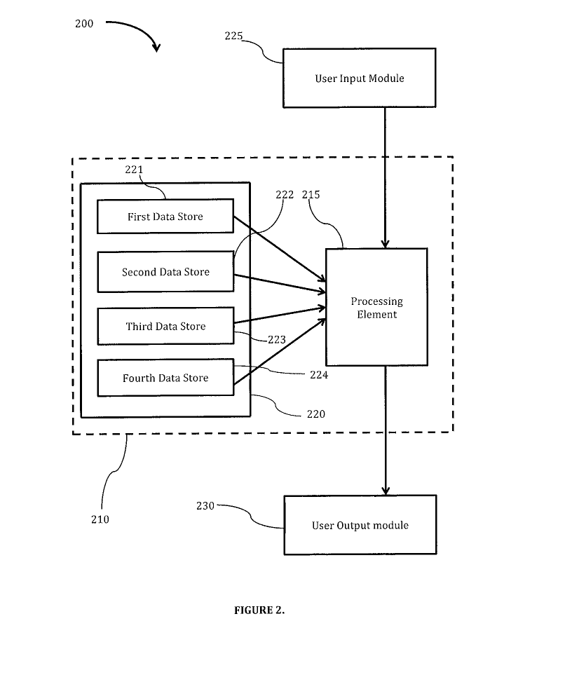

Referring to FIG. 2 shown therein is a preferred implementation of a computer system 200 comprising a memory element 220 wherein the memory element 220 comprises a first data store 221, a second data store 222, a third data store 223 and a fourth data store 224. The first data store 221 comprises a plurality of stored pain patterns assembled in electronic readable format, relating to musculoskeletal or neuro-musculoskeletal impairment. The second data store 222, comprises a plurality of physical therapy examination methods assembled in electronic readable format, relating to musculoskeletal or neuro-musculoskeletal impairment. The third data store 223, comprises a plurality of physical therapy intervention methods, assembled in a computer readable data format, to treat musculoskeletal or neuro-musculoskeletal impairments.

The fourth data store 224 comprises one or more of a plurality of prospective diagnoses assembled in electronic readable format. The diagnoses, may be any movement related, International Classification of Function (ICF) classification, pathoanatomical, biomechanical, neurophysiologic, biopsychosocial and/or medical diagnosis associated with a musculoskeletal impairment or a neuro-musculoskeletal impairment. For example, a diagnosis associated with a lower back pain pattern may be lumbar muscle strain, or spinal stenosis, a diagnosis associated knee pain may be meniscus tear, etc.

In further implementations, more detailed information relating to each diagnosis may be included in the fourth data store 224, for example, a more detailed clinical description of a condition or literature reference thereto, prevalence of a condition, clinical red flags etc.

In at least some implementations, the computer system 200 may be assembled so that a user can access such additional information through the user input module 225, and further confirm or refute a prospective diagnosis using such additional information.

The computer system 200 further comprises a processing element 215 comprising at least one processor or suitable hardware that can perform functions according to computer readable instructions, which may be stored thereon or be otherwise accessible, to link a stored pain pattern with one or more prospective movement diagnoses. The user output module 230 is operable to provide output to an output device in the form of a prospective movement diagnosis. In this implementation, the memory element 210 is further operably coupled to the processing element 215 and both the processing element 215 and memory element 220 are preferably located in one terminal 210. The user input module 225 is operably coupled to the processing element 215 and the user output module 230 is operably coupled to the processing element 215.

The user input module 225 and user output module 230 function substantially the same as the input module 125 and output module 130 of the implementation set forth in FIG. 1. In some implementations, the user input module 225 further may comprise a capability permitting the user to select whether he wishes to receive output data based on or from one or more of the second data store, 222 or the third data store 223, or the fourth data store 224 thus allowing the user to select and sequence the output that is provided to him.

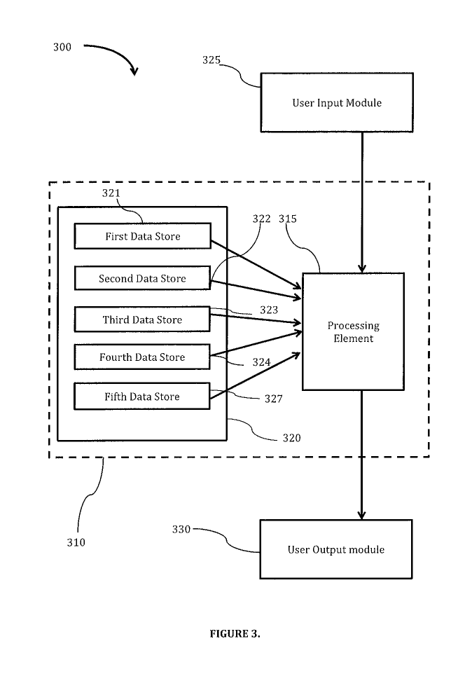

Referring to FIG. 3, shown therein is a preferred implementation of a computer system 300 comprising a memory element 320 wherein the memory element 320 that comprises a first data store 321, a second data store 322, a third data store 323, a fourth data store 324 and a fifth data store 325. The first data store 321, comprises a plurality of stored pain patterns assembled in electronic readable format, relating to musculoskeletal or neuro-musculoskeletal impairment. The second data store 322, comprises a plurality of physical therapy examination methods assembled in electronic readable format, relating to musculoskeletal or neuro-musculoskeletal impairment. The third data store 323, comprises a plurality of physical therapy intervention methods, assembled in a computer readable data format, to treat musculoskeletal or neuro-musculoskeletal impairments. The fourth data store 324, comprises a plurality of prospective movement diagnoses assembled in electronic readable format. The fifth data store 327, comprises a plurality of movement diagnostic tests assembled in electronic readable format.

The processing element 315 comprises at least one processor or suitable hardware for performing functions according to computer readable instructions to link the movement diagnostic tests with a prospective diagnosis. The user output module 330 is operable to provide output to a terminal providing the user with a display in the form of movement diagnostic tests, thereby enabling a user to test a prospective movement diagnosis. The movement diagnostic tests are preferably represented in the form of at least one visual image of a portion of a position or orientation of a part of the human body, preferably an exterior part of the human body. In preferred implementations hereof, the movement diagnostic methods are represented as a movie comprising sequences of images of positions or orientations of a part of the human body. In particularly preferred implementations, healthy and impaired or faulty representations are provided. Some implementations may display all of the different types of information discussed.

The computer system 300 further comprises a processing element 315 which in turn comprises at least one processor or suitable hardware that can perform functions according to computer readable instructions stored thereon, or otherwise accessible, to link a stored pain pattern with one or more prospective movement diagnostic tests. The user output module 330 is operable to provide output data to a terminal in the form of a prospective movement diagnosis. In this implementation the memory element 320 is further operably coupled to the processing element 315 and the processing element 315 and the memory element 320 are preferably located in one terminal 310.

The user input module 325 is operably coupled to the processing element 315 and the user output module 330 is operably coupled to the processing element 315. The user input module 325 and the user output module 330 function substantially the same as the user input modules 125, 225 and user output modules 130, 230 of the implementation set forth in the implementations of FIG. 1. and FIG. 2. In some implementations, the user input module 325 further may comprise a capability permitting the user to select whether he wishes to receive output data from one or more of the second data store, 322 or the third data store 323, or the fourth data store 324, or the fifth data store 327, thus allowing the user to select and sequence the output received.

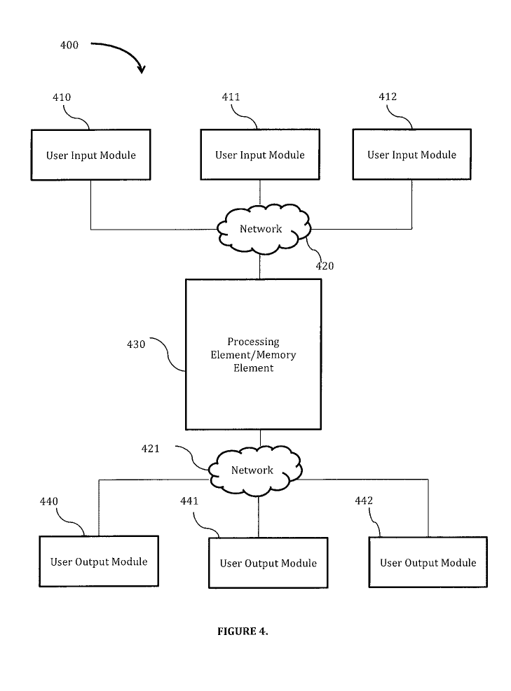

Referring to FIG. 4, shown therein is an implementation of a computer system 400 that comprises a terminal 430 comprising a processing element and a memory element comprised of a first, second and third data store, and optionally a fourth and fifth data store, all as hereinbefore described (but not shown for ease of illustration). The terminal 430 functions as a central terminal and, in this implementation, is operably coupled through a first network 420 to a plurality of user input terminals, 410, 411 and 412. The processing element 430 is further operably coupled through a second network 421 to a plurality of user output modules, 440, 441 and 442. The processing element 430 is capable of executing computer readable instructions thereon, or otherwise accessible, for storing and processing the physiotherapy related information. As used herein “network” means a communications network, such as, but not limited to, a computer network, a local area network, a wide area network, and the internet, which may each be implemented in wired or wireless form.

For illustrative purposes only, three user input modules 410 to 412 and three user output modules 440 to 442 are shown in FIG. 4. It will be understood, that the number of user input and user output modules can be expanded upon to include any number of user input and user output modules operably coupled to the central terminal 430, including to a very large number of user input and user output modules e.g. more than 10,000 or more than 100,000 user input and user output modules.

It will further be understood that the number of networks used in accordance herewith may be varied. In the implementation hereof shown in FIG. 4, a first network 420 and a second network 421 are displayed for illustrative purposes. In alternate implementations, a single network may be used to operably couple both the user input modules and user output modules to a terminal. In further alternate implementations three or more networks may be used. In further alternate implementations the user input and user output device are physically coupled and are substantially provided in one user operable device.

The plurality of user input and user output modules may be used by patients, physical therapists, students, teachers, a combination thereof, or any other users. Each of the input and output user modules, i.e. each of the practitioner and/or patient modules, for example, but not limited to, a desk top computer, a laptop, a tablet, a cellular phone, a smart phone or any other computing unit, further preferably comprises a two dimensional display, such as a TV or a liquid crystal display (LCD), a light-emitting diode (LED) backlit display, a mobile telephone display, a three dimensional display capable of providing output in a user viewable format, a printer or electronic storage device. In this implementation the physical therapist and/or patient output device are operably coupled to communicate data to the central processor 430 via a network.

In further preferred implementations, a physical therapist may select the information provided by a user output module and transmit such information to a patient using a network in order to educate and instruct the patient, such as with respect to the conduct of physiotherapy exercises, for example. Further a physical therapist may select a portion of all information provided by a user output module, e.g. a video, and mark this portion for transmission to a patient, e.g. via e-mail which may comprise hyperlinks to access the information. A transmission of information to a patient may further include a personal message, including for example at least one of reminders, customized information such as, exercise dosage (including but not limited to the number of mobility iterations per exercise and the number of exercise iterations per day, for example), activity limitations (including information (e.g. video) on faulty movements), exercise goals (including information relating to expectation regarding expected improvements (including video of correct movement) and improvement times or timelines), a training plan (including information on functional training (e.g. video information) and therapeutic activities (e.g. video information), or a log to be completed by a user, for example to create a record of performed physical therapy exercises by a patient or improvements of a patient, all which may be automated to be delivered on an iterative basis.

The transmitted information may be provided on a conditional basis, i.e. comprising a notice requiring the user to agree to terms (e.g. regarding liability of the physical therapist, and use limitations). The provided information further may be made available to the user for a limited amount time, e.g. for one week, or one month or six months, or only upon receiving regular confirmation (e.g. once per day or once per week) by the user of use of the information.

In some example implementations, in order to use or access the information provided by the output device, the physical therapist may be charged a fee, and the physical therapist may charge the users a fee in order to access the information, for example a fee per video use (e.g. per hyperlink click).

Users of the information may include patients and physical therapists, as well as other health care information users, such as insurance companies, requiring access to the medical records, which may include the aforementioned logs, of patients, all of whom may be charged to access such information. Thus this example implementation may be further modified to allow a physical therapist to interact with a remotely located patient and to provide physical therapy education and instructions based on pain patterns reported by patients.

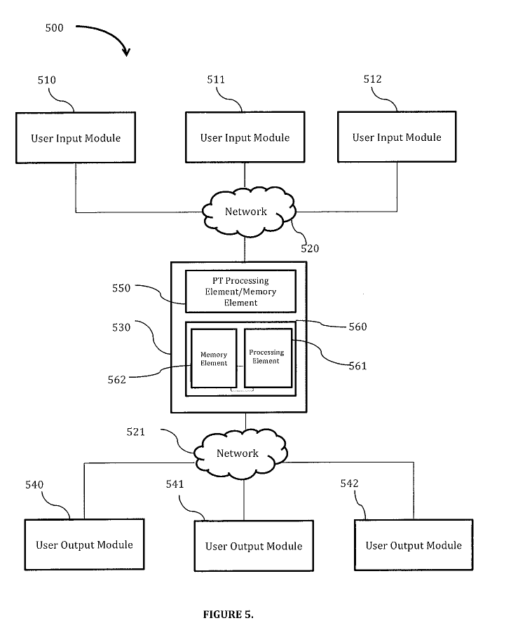

Referring to FIG. 5, shown there is a preferred implementation of a computer system 500 comprising a central processor 530 coupled to a plurality of user input modules 510, 511 and 512 through a first network 520, as well as to a plurality of user output modules 540, 541 and 542, through a second network 521.

The central terminal 530 comprises a first functional module 550 comprising a memory element 562 comprising the first, second and third data stores, and optionally the fourth and/or fifth data stores, assembled in electronic readable format, and a processing element 561 that is capable of executing computer readable instructions thereon, or otherwise accessible, for storing and processing the physiotherapy related information. The first functional module 550 is substantially the same as item 110 in FIG. 1, item 210 in FIG. 2 or item 310 in FIG. 3.

The central terminal 530 additionally comprises a second functional module termed herein the “control access module” 560. The control access module 560 is capable of identifying individual user input modules on presentation by a user input module to the central terminal 530 of an IP address, password or other unique user identifier provided by the user through one of the user input modules 510, 511 or 512. Accordingly, the control access module 560 comprises a memory element 562 comprised of a tangible storage medium comprising a data store assembled in computer usable format capable of storing a plurality of entries comprising unique user identifiers provided through user input modules 510, 511 or 512.

The control access module 560 further comprises a processing element 561 comprising at least one processor or suitable hardware that can perform functions according to computer readable instructions stored thereon or otherwise accessible. These functions may include comparing entries of unique user identifiers in the data store within the memory element 562, with a unique user identifier provided by one of the input user modules 510, 511 or 512 operably coupled to the control access module 560. Upon having attempted to match a unique user identifier from one of the user input modules 510, 511 or 512 with one of the entries of unique user identifiers in the data store within memory element 562, the processing element 561 in the control access unit 560 executes instructions to permit or deny a user input module 510, 511 or 512 in question access to the first functional module 550. In preferred implementations the control access module 560 will deny access of the user input module 510, 511 or 512 in question to the first functional module 550, when the unique user identifier provided by the user input module 510, 511 or 512 is not identical to one of the entries of unique user identifiers in the data store in the memory element 562. Conversely, in preferred implementations, the control access module 560 will grant access of the user input module 510, 511 or 512 in question to the first functional module 550, when the unique user identifier provided by the user input module 510, 511 or 512 in question is identical to one of the entries of unique user identifiers in the data store in the memory element 562.

For example implementations related to FIG. 5, individual users may or may not be charged a fee to obtain access to the first functional module 550. The foregoing implementation is particularly suitable for the delivery of therapy in the form of home exercises or home program instructions.

It will be understood that the number of networks used in accordance herewith may be varied. In the implementation hereof shown in FIG. 5, a first network 520 and a second network 521 are displayed for illustrative purposes. In alternate implementations, a single network is used to operably couple both the user input and user output modules to a processing element. In further alternate implementations three or more networks are used. In yet further alternate implementations the input and output device are physically coupled and substantially provided as one user operable device.

According with the foregoing implementations related to FIG. 5 the present disclosure also provides a computer system for providing information relating to the delivery of physical therapy, the computer system comprising:

(aa) a first functional module comprising:
(a) at least one data store assembled in electronic readable format comprising:
a plurality of stored pain patterns relating to a musculoskeletal or neuro-musculoskeletal impairment of a patient;
a plurality of physical therapy examination methods to examine the musculoskeletal or neuro-musculoskeletal impairment; and
a plurality of physical therapy intervention methods to treat the musculoskeletal or neuro-musculoskeletal impairment;
(b) a data processing element, operably coupled to the at least one data store, and configured to select a stored pain pattern based on an input pain pattern and then select at least one of at least one physical therapy examination method and at least one physical therapy intervention method based on the selected stored pain pattern;
(c) a user input module, operably coupled to the data processing element, operable to receive user input data comprising the input pain pattern; and
(d) a user output module, operably coupled to the data processing element, operable to provide output data to an output device comprising the selected physical therapy examination method and the selected physical therapy intervention method.

(bb) a second functional module comprising:
(e) a second memory element comprising an access data store assembled in electronic readable format comprising a plurality of unique user identifiers; and
(f) a second data processing element comprising computer readable instructions thereon that upon execution cause the data processing element to match a unique user identifier supplied by an input module with a plurality of unique user identifiers stored in the access data store, and establish access of the user input module to the first functional module if there is a correct match.

The computer system may deliver the services to a patient suffering from a musculoskeletal impairment or a neuro-musculoskeletal impairment, to a therapist or any other user.

In further implementations, the data in the data store of the memory element of the access control module may be used to transmit information, for example an e-mail message or text message, to single users, a subset of users or all users of the computer system whose e-mail addresses, IP addresses or other unique information, that permits the transmittal of information to individual users, has been stored in the data store of the memory element of the access control module.

In further implementations the present disclosure provides a method of prescribing physical therapy, the method being implemented by a processing device, the method comprising:
(a) receiving input data comprising an input pain pattern;
(b) selecting a stored pain pattern from at least one data store based on the input pain pattern, the at least one data store comprising a plurality of stored pain patterns relating to a musculoskeletal or neuro-musculoskeletal impairment of a patient;
(c) selecting at least one physical therapy examination method from the at least one second data store based on the selected stored pain pattern, the at least one data store comprising a plurality of physical therapy examination methods to examine the musculoskeletal or neuro-musculoskeletal impairment;
(d) selecting at least one physical therapy intervention method from the at least one data store based on the selected stored pain pattern, the at least one data store comprising a plurality of physical therapy intervention methods to treat the musculoskeletal or neuro-musculoskeletal impairment; and
(e) providing output data to convey the selected at least one physical therapy examination method and the selected at least one physical therapy intervention method.

In some implementations, the method comprises prescribing physical therapy that can be used by a patient suffering from a musculoskeletal impairment or a neuro-musculoskeletal impairment.

In accordance herewith, in at least some implementations, the physical therapy may be prescribed in the form of a home exercise and/or home program instructions.

It should be noted that in the various example embodiments described herein there may be one data store which is used to store the various information. For example, there may be an embodiment in which first data store 121, second data store 122 and third data store 123 are implemented using a single data store. There may be another embodiment in which the single data store is also used to implement the fourth data store 224. There may be another embodiment in which the single data store is also used to implement the fifth data store 327. In some embodiments, the single data store may be used to implement various combinations of the data stores 121, 122, 123, 224 and 327. It some implementations, at least one of the data stores 121, 122, 123, 224 and 327 may be located in a remote location.

At least some of the elements of the various computer systems described herein are implemented via software and may be written in a high-level procedural language such as object oriented programming or a scripting language. Accordingly, the program code may be written in C, C++ or any other suitable programming language and may comprise modules or classes, as is known to those skilled in object oriented programming. Alternatively, at least some of the elements of the various computer systems described herein that are implemented via software may be written in assembly language, machine language or firmware. In either case, the program code can be stored on a storage media or on a computer readable medium that is readable by a general or special purpose electronic device having a processor, an operating system and the associated hardware and software that implements the functionality of at least one of the embodiments described herein. The program code, when read by the electronic device, configures the electronic device to operate in a new, specific and defined manner in order to perform at least one of the methods described herein.

Furthermore, at least some of the methods described herein are capable of being distributed in a computer program product comprising a transitory or non-transitory computer readable medium that bears computer usable instructions for one or more processors. The medium may be provided in various forms such as, but not limited to, one or more diskettes, compact disks, tapes, chips, USB keys, external hard drives, wire-line transmissions, satellite transmissions, internet transmissions or downloads, magnetic and electronic storage media, digital and analog signals, tablet (e.g. iPad) or smartphone (e.g. iPhones) apps, and the like. The computer useable instructions may also be in various forms, including compiled and non-compiled code.

1. A computer system for providing information relating to the delivery of physical therapy services the computer system comprising:
(a) at least one data store assembled in electronic readable format comprising:
a plurality of stored pain patterns relating to a musculoskeletal or neuro-musculoskeletal impairment of a patient;
a plurality of physical therapy examination methods to examine the musculoskeletal or neuro-musculoskeletal impairment; and
a plurality of physical therapy intervention methods to treat the musculoskeletal or neuro-musculoskeletal impairment;
(b) a data processing element, operably coupled to the at least one data store, and configured to select a stored pain pattern based on an input pain pattern and then select at least one of at least one physical therapy examination method and at least one physical therapy intervention method based on the selected stored pain pattern;
(c) a user input module, operably coupled to the data processing element, operable to receive user input data comprising the input pain pattern; and
(d) a user output module, operably coupled to the data processing element, operable to provide output data to an output device comprising the selected physical therapy examination method and the selected physical therapy intervention method.

2. The computer system according to claim 1, wherein at least one of the physical therapy examination method and the physical therapy intervention method are presented in the form of an image comprising orientation and positioning of a body part.

3. The computer system according to claim 1, wherein at least one of the physical therapy examination method and the physical therapy intervention method are presented in the form of a movie comprising a sequence of images displaying the positioning and orientation of a body part over time.

4. The computer system according to claim 3, wherein the movie shows at least one of a body or portion thereof with impaired muscular movement and a body or portion thereof with healthy muscular movement.

5. The computer system according to claim 3, wherein the movie is presented in a format that permits transfer to an output device of a remotely located patient via a personal message system.

6. The computer system according to claim 5, wherein the personal message system comprises at least one of a reminder and exercise performance instructions.

7. The computer system according to claim 1, wherein the at least one data store further comprises a plurality of prospective movement diagnoses, and wherein the processing element is configured to determine one or more prospective movement diagnoses based on the selected stored pain pattern, and wherein the output module is operable to provide output data to an output device comprises the one or more prospective movement diagnoses.

8. The computer system according to claim 7, wherein the at least one data store further comprises a plurality of movement diagnostic tests capable of testing the prospective movement diagnosis and wherein processing element is configured to determine one or more movement diagnostic tests with the determined one or more prospective movement diagnoses and wherein the output module is operable to provide output data to an output device, the output data comprising movement diagnostic tests.

9. The computer system according to claim 8, wherein the movement diagnostic tests are presented in the form of a movie comprising at least one of a sequence of the position and orientation of a body or body part over time.

10. The computer system according to claim 1, wherein a plurality of input and output modules are coupled to the processing element.

11. The computer system according to claim 1, wherein the physical therapy examination methods and the physical therapy intervention methods are linked with the stored pain patterns based on at least one of clinical practice guidelines, pattern recognition or clinical reasoning.

12. The computer system according to claim 1, wherein the physical therapy intervention methods comprise at least one of a manual therapy, a therapeutic modality, a physiotherapeutic exercise or a an exercise for patient and motor reeducation.

13. The computer system according to claim 12, wherein the therapeutic modality is selected for the therapeutic modalities comprising treatment by at least one of ultrasound, heat, ice and electrical stimulation.

14. The computer system according to claim 1, wherein the physical therapy services are provided to a patient is suffering from a musculoskeletal impairment or a neuro-musculoskeletal impairment that results in at least one of impaired muscular strength, impaired mobility or impaired motor coordination.

15. The computer system according to claim 1, wherein the computer system provides physical therapy information comprising at least one of home exercise or home program instructions.

16. A computer system for providing information relating to the delivery of physical therapy services, the computer system comprising:
(aa) a first functional module comprising:
(a) at least one data store assembled in electronic readable format comprising:
a plurality of stored pain patterns relating to a musculoskeletal or neuro-musculoskeletal impairment of a patient;
a plurality of physical therapy examination methods to examine the musculoskeletal or neuro-musculoskeletal impairment; and
a plurality of physical therapy intervention methods to treat the musculoskeletal or neuro-musculoskeletal impairment;
(b) a data processing element, operably coupled to the at least one data store, and configured to select a stored pain pattern based on an input pain pattern and then select at least one of at least one physical therapy examination method and at least one physical therapy intervention method based on the selected stored pain pattern;
(c) a user input module, operably coupled to the data processing element, operable to receive user input data comprising the input pain pattern; and
(d) a user output module, operably coupled to the data processing element, operable to provide output data to an output device comprising the selected physical therapy examination method and the selected physical therapy intervention method;
(bb) a second functional module comprising:
(e) a second memory element comprising an access data store assembled in electronic readable format comprising a plurality of unique user identifiers; and
(f) a second data processing element comprising computer readable instructions thereon that upon execution cause the data processing element to match a unique user identifier supplied by an input module with a plurality of unique user identifiers stored in the access data store, and establish access of the user input module to the first functional module if there is a correct match.

17. The computer system according to claim 16, wherein the plurality of user input modules are operably coupled to the data processing element through a first network, and the plurality of user output modules are operably coupled the data processing element through a second network and the first and the second networks may be the same or different.

18. The computer system according to claim 16, wherein the computer system provides physical therapy data comprising at least one of home exercise or home program instructions.

19. A method of prescribing physical therapy, the method being implemented by a processing device, the method comprising:
(a) receiving input data comprising an input pain pattern;
(b) selecting a stored pain pattern from at least one data store based on the input pain pattern, the at least one data store comprising a plurality of stored pain patterns relating to a musculoskeletal or neuro-musculoskeletal impairment of a patient;
(c) selecting at least one physical therapy examination method from the at least one second data store based on the selected stored pain pattern, the at least one data store comprising a plurality of physical therapy examination methods to examine the musculoskeletal or neuro-musculoskeletal impairment;
(d) selecting at least one physical therapy intervention method from the at least one data store based on the selected stored pain pattern, the at least one data store comprising a plurality of physical therapy intervention methods to treat the musculoskeletal or neuro-musculoskeletal impairment; and
(e) providing output data to convey the selected at least one physical therapy examination method and the selected at least one physical therapy intervention method.

20. The method according to claim 19, wherein the method further comprises prescribing a physical therapy regimen to a patient based on the output data.

21. The method according to claim 20, wherein the prescription comprises at least one of physical therapy for home exercise and home program instructions.

22. A computer readable medium comprising a plurality of instructions executable on a processing element of an electronic device for adapting the electronic device to implement a method of physical therapy related information, wherein the method is performed according to claim 19.
